(19) United States
(12) Patent Application Publication
(10) Pub. No.: US 2009/0070435 A1
(43) Pub. Date: Mar. 12, 2009

(54) Targeted websites based on a user profile

(75) Inventor: Raj Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/900,267

(22) Filed: Sep. 10, 2007

(51) Int. Cl. G06F 15/16

(52) U.S. Cl. 709/218

(57) ABSTRACT

A method, apparatus and system of targeted websites based on a user profile are disclosed. In one embodiment, a method includes generating profile information of a user based on interests of the user in a social network, associating links to the user based on contact information added by the user and by other users, creating a character profile of the user based on the profile information and the contact information, and selecting a targeted website address based on the character profile when the user requests access to a particular entity associated with targeted website. The method may further include applying a time of year filter when selecting the targeted website, such that the time of year filter automatically determines what information to show the user in the website based on an age an a marital status of the user captured through the profile information.

### FIELD OF TECHNOLOGY

This disclosure relates generally to the technical fields of communications and, in one example embodiment, to a method, apparatus, and system of targeted websites based on a user profile.

### BACKGROUND

A social network (e.g., Facebook®, LinkedIn®, Fatdoor®, MySpace®, etc.) may include profile information about users (e.g., likes, dislikes, groups, etc). The profile information may be contributed by individual users, their friends, and/or their neighbors. In addition, the profile information may include birth year information, age information, time of year information, and/or marital status information, etc. In some social networks (e.g., Fatdoor®), a user may access an internal or external website (e.g., a department store website) directly from within the social network.

For example, a user of Fatdoor® may search for a particular restaurant and access the restaurant's website through a referral, link, and/or a search query from within Fatdoor®. However, the internal or external website (e.g., built inside the social network or external to it) may not tailor an experience of the user based on the profile information. Rather, the internal or external website may only examine a cookie information having previously entered information by the user and/or general browser information. As such, the experience of the user may not be tailored to his/her likes, dislikes and/or preferences based on information in the user profile.

### SUMMARY

A method, apparatus and system of targeted websites based on a user profile are disclosed. In one aspect, a method includes generating profile information of a user based on interests of the user in a social network, associating links to the user based on contact information added by the user and by other users, creating a character profile of the user based on the profile information and the contact information, and selecting a targeted website address (e.g., may be internal to the social network embodying the profile information) based on the character profile when the user requests access to a particular entity associated with a targeted website. The method may further include applying a time of year filter when selecting the targeted website, such that the time of year filter automatically determines what information to show the user in the website based on an age and a marital status of the user captured through the profile information.

In another aspect, a method includes providing descriptive information of pre-seeded data having characteristics of people and communities in a geographic area, generating a community network of user profiles based on the pre-seeded data, each user profile associated with a specific geographic location, at least some of the specific geographic locations associated with a business and/or a residence, associating a first user with a first user profile having a specific geographic location associated with a first business, claiming the first user profile (e.g., may include verifying an email address, a business license, and/or a physical postal address, etc.), selecting the first user profile by a second user profile based on a set of characteristics derived from the second user profile and the pre-seeded data, and generating a three-dimensional map view embodied by the community network, a portion of the user profiles represented at locations in the three-dimensional map view corresponding with the specific geographic locations of the portion of the user profiles, the first user profile, and information, based on a portion of the set of characteristics derived from the second user profile and the pre-seeded data.

The first user profile may display advertisements based on the information, a link to a website associated with the first business (e.g., may include a web page and/or a link associated with the business), and/or the website associated with the first business.

The method may further include generating an online transaction associated with the second user profile and the first business. The online transaction may include reserving a product and/or a service associated with the business, ordering the product and/or the service associated with the business and/or generating an online payment transaction associated with the business. The generating an advertisement may include displaying an online advertisement, generating a printed publication, generating a printed publication from an online advertisement, generating an advertisement based on a predetermined criterion associated with a second user profile, and generating a display view of the first user profile and the advertisement, the display view associated with the second user profile.

In yet another aspect, a system includes a geographic community environment, a community network module of the geographic community environment, the community network module to include user profiles, each user profile to include an associated specific geographic location, a portion of the specific geographic locations associated with a business and/or a residence, a map module of the geographic community environment to include map data which serve as a basis to render a three-dimensional map view in the geo-spatial environment which identifies physical structures having specific geographic locations, a claim module of the geographic community environment to claim a first user profile having a specific geographic location associated with a business, a display module of the geographic community environment to generate a display view of the three-dimensional map view embodied by the community network and a first user profile represented at a location in the three-dimensional map view associated with the specific geographic location of the first user profile, and a transaction module of the geographic community environment to generate a promotion-related activity associated with the first user profile and the business. In addition, the claim module may verify a proof of business ownership (e.g., may include an email address, a business license, and/or a physical postal address verification, etc.).

The system may further include a review control module of the geographic community environment to control the display of a review associated with the business. The system may also include a payment module of the geographic community environment to permit selective control over display of the review associated with the business upon a payment transaction. In addition, the system may include a website matching module of the geographic community environment to incorporate a website (e.g., may include a display of a web page and/or a link associated with a business) associated with the business into the first user profile. The website matching module may include a reservation transaction to generate a reservation associated with the product and/or the service associated with the business, an order transaction to order the product and/or the service associated with the business and an online payment transaction associated with the business.

The system may further include an advertisement module of the geographic community environment to generate an advertisement associated with the first user profile. The advertisement module may include an advertisement, based on a predetermined criterion associated with a second user profile, displayed in conjunction with the first user profile. Further, the advertisement may include an online advertisement display, a printed publication (e.g., may be a coupon, a flyer, and/or a post card) and/or a printed publication generated from an online advertisement, etc. The system may also include a poll module of the geographic community environment to generate a poll associated with the business. In addition, the system may include a sponsorship module of the geographic community environment to generate a list of groups seeking sponsorship, and to display the first user profile in conjunction with a list of groups sponsored by the business. The system may yet include a wiki module of the geographic community environment to generate in a display view, a wiki profile associated with a user profile and content associated with the wiki profile.

In a further aspect, a geographic community environment includes a first instruction set to enable a community network, to include a user database to include user profiles, the community network associated with map data, in which the community network is associated with specific geographic locations identifiable in the map data and a portion of the specific geographic locations are associated with a business and/or a residence, a second instruction set integrated with the first instruction set to claim a user profile having a specific geographic location associated with a business, and a third instruction set integrated with the first instruction set and the second instruction set to generate a promotion-related activity associated with the user profile and the business.

The geographic community environment may further include a fourth instruction set integrated with the first instruction set, the second instruction set and the third instruction set to selectively display in conjunction with the user profile a review associated with the business.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geographic community environment having a website matching module communicating with targeted websites, according to one embodiment.

FIG. 2 is an exploded view of the website matching module of FIG. 1, according to one embodiment.

FIG. 3 is a table view displaying user profile information, according to one embodiment.

FIG. 4 is a diagrammatic system view of a data processing system in which any of the embodiments disclosed herein may be performed, according to one embodiment.

FIG. 5 is a process flow of selecting a targeted website address based on a character profile and applying a time of year filter, according to one embodiment.

FIG. 6 is a process flow of generating a three-dimensional map view displaying the user profiles represented at locations, according to one embodiment.

Other features of the present embodiments will be apparent from the accompanying drawings and from the detailed description that follows.

### DETAILED DESCRIPTION

A method, apparatus and system of targeted websites based on a user profile are disclosed. In the following description, for the purposes of explanation, numerous specific details are set forth in order to provide a thorough understanding of the various embodiments. It will be evident, however to one skilled in the art that the various embodiments may be practiced without these specific details.

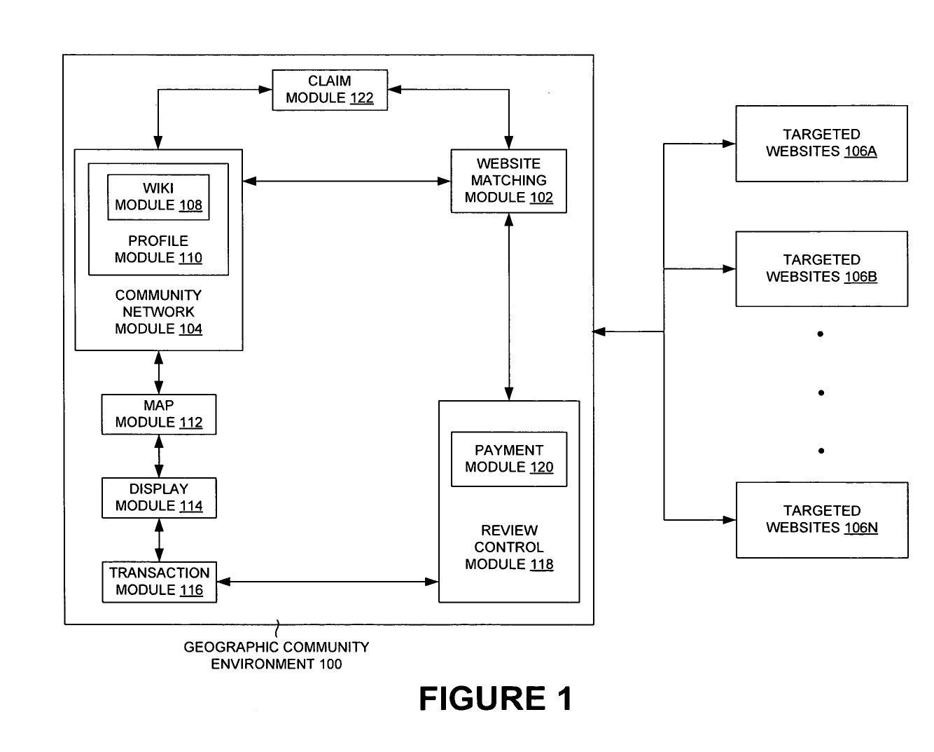

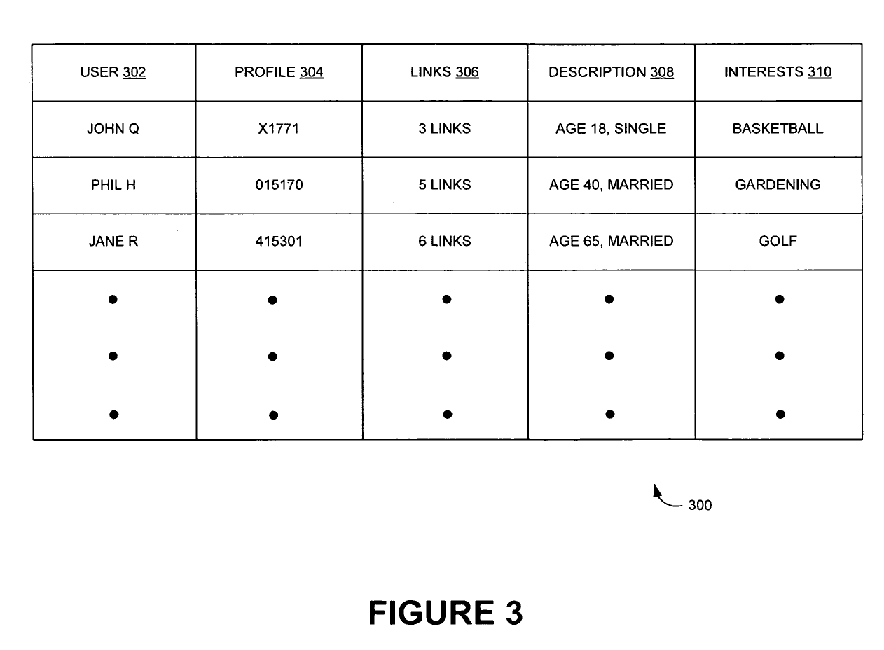

In one embodiment, a method includes generating profile information of a user (e.g., the users 302 illustrated in FIG. 3) based on interests of the user in a social network (e.g., the geographic community environment 100 of FIG. 1), associating links to the user based on contact information added by the user and by other users (e.g., using the community network module 104 of FIG. 1), creating a character profile of the user based on the profile information and the contact information, and selecting a targeted website address based on the character profile when the user requests access to a particular entity associated with a targeted website (e.g., the targeted websites 106A-N of FIG. 1).

In another embodiment, a method includes providing descriptive information of pre-seeded data having characteristics of people and communities in a geographic area, generating a community network of user profiles based on the pre-seeded data (e.g., using the community network module 104 of FIG. 1), each user profile associated with a specific geographic location (e.g., in the geographic community environment 100 illustrated in FIG. 1), the specific geographic locations associated with a business and a residence, associating a first user with a first user profile having a specific geographic location associated with a first business, claiming the first user profile (e.g., using the wiki module 108 and/or the profile module 110 of FIG. 1), selecting the first user profile by a second user profile based on a set of characteristics derived from the second user profile and the pre-seeded data, and generating a three-dimensional map view embodied by the community network, a portion of the user profiles represented at locations in the three-dimensional map view corresponding with the specific geographic locations of the portion of the user profiles, the first user profile, and information, based on a portion of the set of characteristics derived from the second user profile and the pre-seeded data.

In yet another embodiment, a system includes a geographic community environment (e.g., the geographic community environment 100 of FIG. 1), a community network module (e.g., the community network module 104 of FIG. 1) of the geographic community environment 100, the community network module 104 to include user profiles, each user profile to include an associated specific geographic location, a portion of the specific geographic locations associated with a business and/or a residence, and a map module (e.g., the map module 112 of FIG. 1) of the geographic community environment 100 to include map data which serve as a basis to render a three-dimensional map view in the geo-spatial environment which identifies physical structures having specific geographic locations, a claim module (e.g., the claim module 122 of FIG. 1) of the geographic community environment 100 to claim a first user profile having a specific geographic location associated with a business.

The system also includes a display module (e.g., the display module 114 of FIG. 1) of the geographic community environment 100 to generate a display view of the three-dimensional map view embodied by the community network and a first user profile represented at a location in the three-dimensional map view associated with the specific geographic location of the first user profile, and a transaction module (e.g., the transaction module 116 of FIG. 1) of the geographic community environment 100 to generate a promotion-related activity associated with the first user profile and the business.

In a further embodiment, a geographic community environment (e.g., the geographic community environment 100 of FIG. 1) includes a first instruction set to enable a community network, to include a user database to include user profiles, the community network associated with map data, in which the community network is associated with specific geographic locations identifiable in the map data and a portion of the specific geographic locations are associated with a business and a residence, a second instruction set integrated with the first instruction set to claim a user profile (e.g., using the claim module 122 of FIG. 1) having a specific geographic location associated with a business and a third instruction set integrated with the first instruction set and the second instruction set to generate a promotion-related activity associated with the user profile and the business.

FIG. 1 is a system view of a geographic community environment 100 having a website matching module 102 communicating with targeted websites 106A-N, according to one embodiment. Particularly, FIG. 1 illustrates the geographic community environment 100, the website matching module 102, a community network module 104, the targeted websites 106A-N, a wiki module 108, a profile module 110, a map module 112, a display module 114, a transaction module 116, a review control module 118, a payment module 120 and a claim module 122, according to one embodiment.

The geographic community environment 100 may enable users having user profiles to select the targeted websites 106A-N using the website matching module 102. For example, the user having a profile (e.g., people profile, a business profile, and/or a group profile, etc.) may be able to benefit from the rich networking opportunities by selecting various targeted websites 106A-N in an online community of the geographic community environment 100.

The website matching module 102 may incorporate the targeted websites 106A-N associated with businesses into a profile (e.g., people profile, business profile, and/or group profile, etc.) of the user. For example, the targeted websites 106A-N may be selected based on creation of a character profile (e.g., created based on profile information and contact information of the user in a network (e.g., a social network, a community network, etc.) of the user who can request access to a particular entity (e.g., people entity, business entity, group entity, etc.) associated with the targeted websites 106A-N. In addition, the targeted websites 106A-N may be searched by the user corresponding to people entity (e.g., based on location and interests), business entity (e.g., based on name and location) and group entity (e.g., based on location, tags and common interests).

In one embodiment, the website matching module 102 may further include a reservation transaction, an order transaction and an online payment transaction associated with a product and/or a service associated with the business (e.g., processed by the transaction module 116 of FIG. 1). The community network module 104 may generate a community network including user profiles of the users based on the pre-seeded data associated with specific geographic locations of a business and/or a residence. The targeted websites 106A-N may be any one of internal websites which are built inside the network (e.g., a social network, a community network, etc.) embodying the profile information or external websites which are built external to the network. In addition, optimizing the relevance during selecting the targeted websites 106A-N by the user may be based on the kind of profile (e.g., people profile, business profile and/or group profile, etc.). The wiki module 108 may generate a wiki profile (e.g., a publicly editable profile, an unclaimed profile, etc.) having a content associated with the user.

The profile module 110 may enable generation of profile information and contact information of the user based on interests and locations of the user of the network (e.g., a social network, a community network, etc.). The profile information of the user may also be associated with links (e.g., such as friends, dating, business associations, activity partners, family, connections, other contacts, etc.) connected to the user along with the contact information (e.g., added by the user and other user).

The map module 112 may process (e.g., provide, store, generate, render, etc.) a three-dimensional map view in the geo-spatial environment which identifies physical structures (e.g., residences, businesses, civic structures, etc.) having a specific geographic location. The display module 114 may generate a display view of the three-dimensional map view embodied by the community network along with the user profiles represented at a location in the three-dimensional map view. The transaction module 116 may generate a promotion-related activity associated with the user profiles and the business.

The review control module 118 may control the display of reviews associated with the business. The payment module 120 may permit selective control over display of the reviews associated with the business upon a payment transaction. The claim module 122 may enable the user to claim the user profiles having a specific geographic location associated with a business and/or a resident prior to creating the character profile. For example, the user (e.g., someone who has signed on to the online community and claimed a profile) may provide the profile information and the contact information for creating the character profile having previously claimed his/her profile.

In the example embodiment illustrated in FIG. 1, the geographic community environment 100 includes the website matching module 102, the community network module 104, the map module 112, the display module 114, the transaction module 116, the review control module 118, the payment module 120 and the claim module 122. The geographic community environment 100 having the website matching module 102 communicates with the targeted websites 106A-N. The community network module 104 includes the profile module 110 having the wiki module 108.

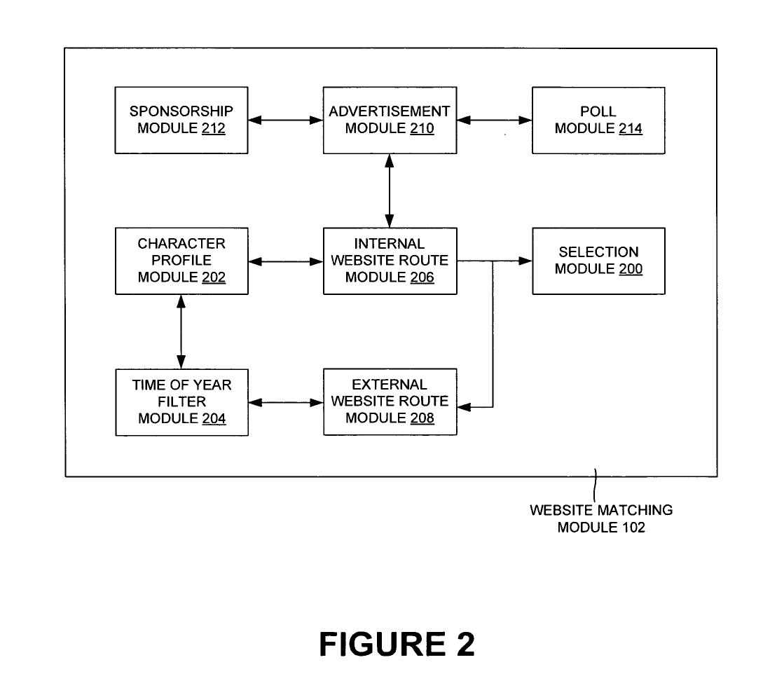

In one embodiment, profile information of a user may be generated (e.g., using the profile module 110 of FIG. 1) based on interests of the user in the social network. The links to the user may be associated based on contact information added by the user and other users. A character profile of the user may be created (e.g., using character profile module 202 of FIG. 2) based on the profile information and the contact information. A targeted website address (e.g., may be internal to the social network embodying the profile information) may be selected (e.g., through the targeted websites 106A-N of FIG. 1) based on the character profile when the user requests access to a particular entity associated with the targeted websites 106A-N.

In another embodiment, descriptive information of pre-seeded data having characteristics of people and communities in a geographic area may be provided. The community network of user profiles may be generated (e.g., using the community network module 104 of FIG. 1) based on the pre-seeded data, each user profile associated with a specific geographic location, the specific geographic locations associated with a business and/or a residence. A first user may be associated with a first user profile having a specific geographic location associated with a first business. In addition, the first user profile may be claimed (e.g., may include verifying an email address, a business license, and/or a physical postal address). In one embodiment, the first user profile may be selected (e.g., using the selection module 200 of FIG. 2) by a second user profile based on a set of characteristics derived from the second user profile and the pre-seeded data.

Further, the first user profile may display advertisements based on information, a link to a website associated with the first business (e.g., may include a web page and/or a link associated with the business) and/or the website associated with the first business. A three-dimensional map view embodied by the community network may be generated (e.g., using the map module 112 of FIG. 1), a portion of the user profiles represented at locations in the three-dimensional map view corresponding with the specific geographic locations of the portion of the user profiles, the first user profile, and information, based on a portion of the set of characteristics derived from the second user profile and the pre-seeded data.

An online transaction associated with the second user profile and the first business may be generated (e.g., using the website matching module 102 of FIG. 1). The online transaction may include reserving a product and/or a service associated with the business and ordering the product and/or the service associated with the business. The online payment transaction associated with the business may be generated.

The community network module 104 of the geographic community environment 100 may include user profiles, each user profile to include an associated specific geographic location, a portion of the specific geographic locations associated with a business and/or a residence. The map module 112 of the geographic community environment 100 may include map data which serve as a basis to render the three-dimensional map view in the geo-spatial environment which identifies physical structures having specific geographic locations. The website matching module 102 of the geographic community environment 100 may incorporate a website (e.g., may include a display of a web page and/or a link associated with a business) associated with the business into the first user profile. In addition, the website matching module 102 may include a reservation transaction to generate a reservation associated with a product and/or a service associated with the business, an order transaction to order the product and/or the service associated with the business and an online payment transaction associated with the business.

The geographic community environment 100 may include a first instruction set to enable the community network, to include a user database to include user profiles, the community network associated with map data, in which the community network is associated with specific geographic locations identifiable in the map data and a portion of the specific geographic locations are associated with a business and/or a residence.

In addition, the geographic community environment 100 may further include a second instruction set integrated with the first instruction set to claim the user profile (e.g., using the claim module 122 of FIG. 2) having the specific geographic location associated with the business and a third instruction set integrated with the first instruction set and the second instruction set to generate a promotion-related activity (e.g., using the transaction module 116 of FIG. 1) associated with the user profile and the business. The geographic community environment 100 may also include a fourth instruction set integrated with the first instruction set, the second instruction set and the third instruction set to selectively display (e.g., using the payment module 120 of FIG. 2) in conjunction with the user profile, a review associated with the business.

FIG. 2 is an exploded view of the website matching module 102 of FIG. 1, according to one embodiment. Particularly, FIG. 2 illustrates a selection module 200, a character profile module 202, a time of year filter module 204, an internal website route module 206, an external website route module 208, an advertisement module 210, a sponsorship module 212 and a poll module 214, according to one embodiment.

The selection module 200 may enable selection of a targeted website 106 associated with a targeted website address based on a character profile by the user having a user profile. The character profile module 202 may enable creation of a character profile (e.g., having characteristics derived from the user profile and the pre-seeded data) of the user based on profile information and contact information. The time of year filter module 204 may apply a time of year filter when selecting the targeted websites 106A-N. For example, the time of the year filter may automatically determine information to be displayed to the user in the website based on age and a marital status (e.g., single, committed, married, divorced, etc.) of the user captured through the profile information.

The internal website route module 206 may enable identification of internal targeted websites 106A-N built inside the community network embodying the profile information for selection among the targeted websites 106A-N. The external website route module 208 may enable identification of external targeted websites 106A-N built external to the network (e.g., a social network, a community network, etc.) based on determination of information to be displayed in the website. The advertisement module 210 may generate an advertisement associated with the user profile. For example, the advertisement may include an online advertisement display, a printed publication and a printed publication generated from an online advertisement.

In one embodiment, the advertisement module 210 may further include an advertisement generated based on a predetermined criterion associated with the user profile displayed in conjunction with a list of groups (e.g., the targeted websites 106A-N). The sponsorship module 212 may generate a list of groups seeking sponsorship and to display the targeted websites 106A-N in conjunction with the list of groups sponsored by the business. The poll module 214 may generate a poll associated with the business.

In the example embodiment illustrated in FIG. 2, the website matching module 102 includes the selection module 200, the character profile module 202, the time of year filter module 204, the internal website route module 206, the external website route module 208, the advertisement module 210, the sponsorship module 212, and the poll module 214 interacting with each other.

A time of year filter may be applied (e.g., using the time of year filter module 204 of FIG. 2) when selecting the targeted websites 106A-N, such that the time of year filter automatically determines what information to show the user in the website based on age and a marital status of the user captured through the profile information. The advertisement module 210 of the geographic community environment 100 may generate an advertisement associated with the first user profile. In one embodiment, generating the advertisement may include displaying an online advertisement, generating a printed publication, generating a printed publication from an online advertisement, generating an advertisement based on a predetermined criterion associated with a second user profile and/or generating a display view of the first user profile (e.g., using the display module 114 of FIG. 1) and the advertisement, the display view associated with the second user profile.

In addition, the advertisement may include an online advertisement display, a printed publication (e.g., may include a coupon, a flyer, and a post card) and/or a printed publication generated from an online advertisement. The claim module 122 may verify a proof of business ownership (e.g., an email address, a business license and/or a physical postal address verification, etc.)

FIG. 3 is a table view displaying user profile information, according to one embodiment. Particularly, FIG. 3 illustrates a user field 302, a profile field 304, links field 306, descriptions field 308 and interests field 310, according to one embodiment.

The user field 302 may display an identifier (e.g., name, username, etc.) referencing users associated with user profiles in a geographic area of a geo-spatial environment. The profile field 304 may provide profile information of the user having a unique number in the geographic community environment 100. The links field 306 may provide links to the user based on contact information added by the user and by other users of the geographic community environment 100. The descriptions field 308 may provide descriptive information of the user, such as age and relationship status (e.g., single, committed, married, divorce, etc.) of the user. The interests field 310 may display information associated with interests of the user of the geographic community environment 100.

In the example embodiment illustrated in FIG. 3, the user field 302 displays “John Q” in the first row, “Phil H” in the second row and “Jane R” in the third row of the user field column 302. The profile field 304 displays “X1771” in the first row, “015170” in the second row and “415301” in the third row, indicating the unique number assigned to each user in the geographic community environment 100 in the profile field column 304. The links field 306 displays “3 links” in the first row, “5 links” in the second row and “6 links” in the third row, indicating the links of each user connected to the relevant targeted websites 106A-N in the geographic community environment 100 in the links field column 306.

The descriptions field 308 displays “Age 18, Single” in the first row (e.g., indicating that the user John Q is 18 years old and his relationship status is single), “Age 40, Married” in the second row (e.g., indicating that the user Phil L is 40 years old and his relationship status is married), and “Age 65, Married” in the third row (e.g., indicating that the user Jane R is 65 years old and her relationship status is married), in the descriptions field column 308. The interests field 310 displays “Basketball” in the first row, “Gardening” in the second row and “Golf” in the third row, indicating the interests of each user in the interests field column 310.

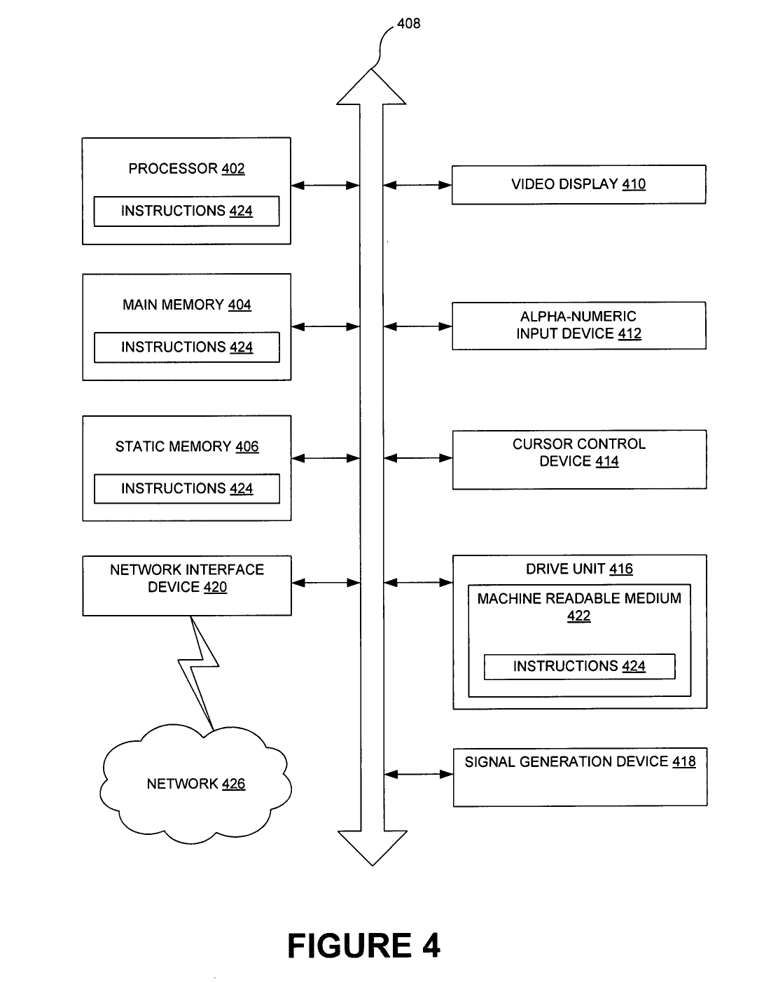

FIG. 4 is a diagrammatic system view 400 of a data processing system in which any of the embodiments disclosed herein may be performed, according to one embodiment. Particularly, the diagrammatic system view 400 of FIG. 4 illustrates a processor 402, a main memory 404, a static memory 406, a bus 408, a video display 410, an alpha-numeric input device 412, a cursor control device 414, a drive unit 416, a signal generation device 418, a network interface device 420, a machine readable medium 422, instructions 424 and a network 426, according to one embodiment.

The diagrammatic system view 400 may indicate a personal computer and/or a data processing system in which one or more operations disclosed herein may be performed. The processor 402 may be a microprocessor, a state machine, an application-specific integrated circuit, a field programmable gate array, etc. (e.g., Intel® Pentium® processor). The main memory 404 may be a dynamic random access memory and/or a primary memory of a computer system. The static memory 406 may be a hard drive, a flash drive, and/or other memory information associated with the data processing system.

The bus 408 may be an interconnection between various circuits and/or structures of the data processing system. The video display 410 may provide graphical representation of information on the data processing system. The alpha-numeric input device 412 may be a keypad, a keyboard and/or any other input device of text (e.g., a special device to aid the physically challenged). The cursor control device 414 may be a pointing device such as a mouse.

The drive unit 416 may be a hard drive, a storage system, and/or other longer term storage subsystem. The signal generation device 418 may be a bios and/or a functional operating system of the data processing system. The network interface device 420 may be a device that may perform interface functions such as code conversion, protocol conversion and/or buffering required for communication to and from the network 426. The machine readable medium 422 may provide instructions on which any of the methods disclosed herein may be performed. The instructions 424 may provide source code and/or data code to the processor 402 to enable any one/or more operations disclosed herein.

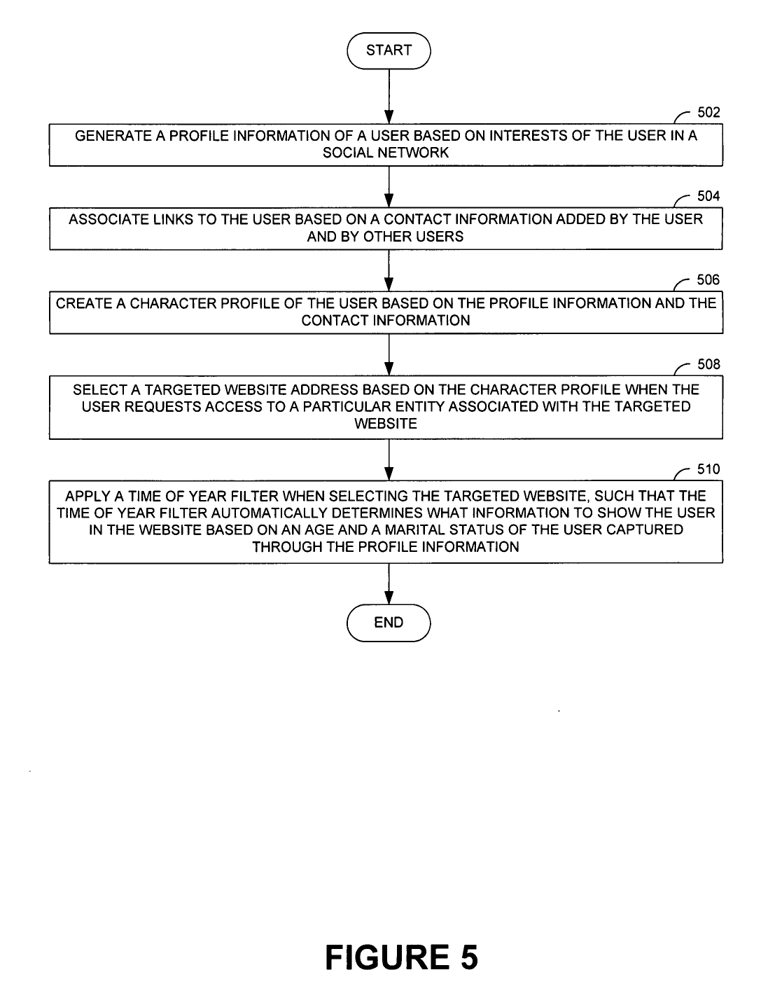

FIG. 5 is a process flow of selecting a targeted website address based on a character profile and applying a time of year filter, according to one embodiment. In operation 502, a profile information of a user may be generated (e.g., using the profile module 110 of FIG. 1) based on interests of the user in a social network. In operation 504, links to the user may be associated (e.g., through the website matching module 102 of FIG. 1) based on contact information added by the user and by other users. In operation 506, the character profile of the user may be created (e.g., using the character profile module 202 of FIG. 2) based on the profile information and/or the contact information.

In operation 508, a targeted website address may be selected (e.g., using the selection module 200 of FIG. 2) based on the character profile when the user requests access to a particular entity (e.g., people entity, business entity, group entity, etc.) associated with the targeted website (e.g., of the targeted websites 106A-N of FIG. 1). In operation 510, the time of year filter may be applied (e.g., using the time of year filter module 204 of FIG. 2) when selecting the targeted website 106, such that the time of year filter automatically determines what information to show the user in the website based on an age and a marital status (e.g., single, committed, married, divorced, etc.) of the user captured through the profile information.

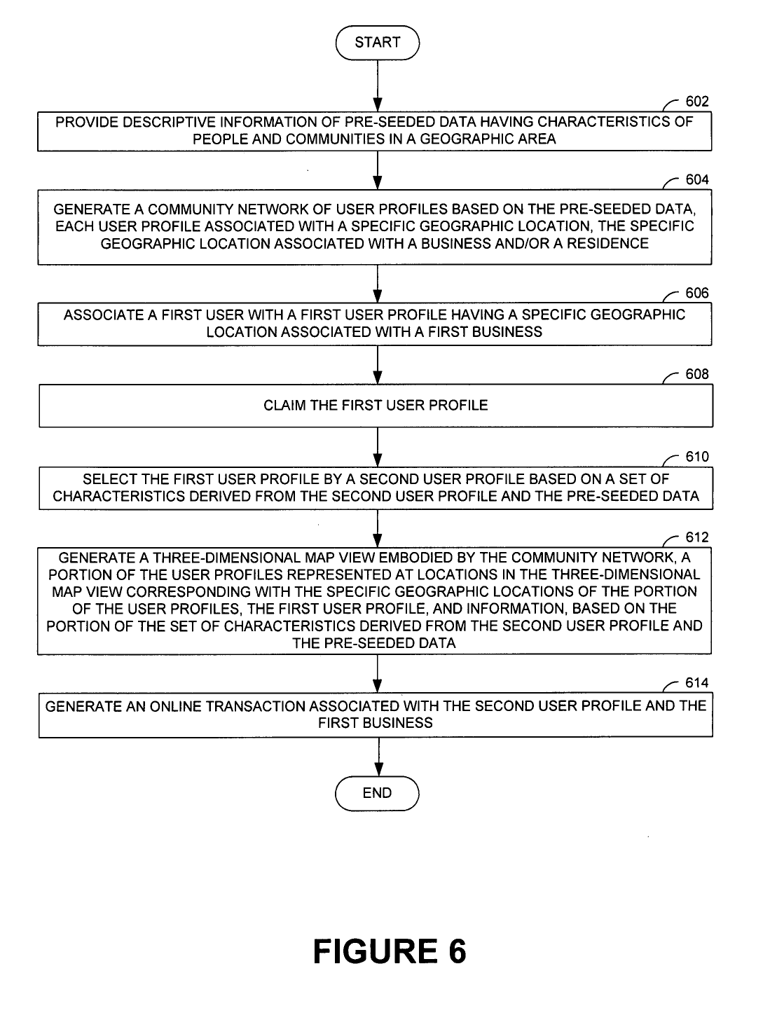

FIG. 6 is a process flow of generating a three-dimensional map view displaying the user profiles represented at locations, according to one embodiment. In operation 602, descriptive information of pre-seeded data having characteristics of people and communities in a geographic area (e.g., the geographic community environment 100 of FIG. 1) may be provided (e.g., using the character profile module 202 of FIG. 2). In operation 604, a community network of user profiles may be generated (e.g., using the community network module 104 of FIG. 1) based on the pre-seeded data, each user profile associated with a specific geographic location, the specific geographic locations associated with a business and/or a residence. In operation 606, a first user may be associated (e.g., the community network module 104 of FIG. 1) with a first user profile having a specific geographic location associated with a first business. In operation 608, the first user profile may be claimed (e.g., using the claim module 122 of FIG. 1).

In operation 610, the first user profile may be selected by the second user profile (e.g., through the selection module 200 of FIG. 2) based on a set of characteristics derived from the second user profile and the pre-seeded data. In operation 612, the three-dimensional map view embodied by the community network may be generated (e.g., through the map module 112 of FIG. 1), a portion of the user profiles represented at locations in the three-dimensional map view corresponding with the specific geographic locations of the portion of the user profiles, the first user profile, and information, based on a portion of the set of characteristics derived from the second user profile and the pre-seeded data. In operation 614, an online transaction associated with the second user profile and the first business may be generated (e.g., using the transaction module 116 of FIG. 1).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or in Digital Signal Processor (DSP) circuitry).

For example, the website matching module 102, the community network module 104, the wiki module 108, the profile module 110, the map module 112, the display module 114, the transaction module 116, the review control module 118, the payment module 120, the claim module 122, the character profile module 202, the time of year filter module 204, the internal website route module 206, the external website route module 208, the advertisement module 210, the sponsorship module 212, and the poll module 214 module, and other modules of FIGS. 1-6 may be enabled using a website matching circuit, a community network circuit, a wiki circuit, a profile circuit, a map circuit, a display circuit, a transaction circuit, a review control circuit, a payment circuit, a claim circuit, a character profile circuit, a time of year filter circuit, an internal website route circuit, an external website route circuit, an advertisement circuit, a sponsorship circuit, and a poll circuit, and other circuits using one or more of the technologies described herein.

In addition, it will be appreciated that the various operations, processes, and methods disclose herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method comprising:
generating profile information of a user based on interests of the user in a social network;
associating links to the user based on contact information added by the user and by other users;
creating a character profile of the user based on the profile information and the contact information; and
selecting a targeted website address based on the character profile when the user requests access to a particular entity associated with a targeted website.

2. The method of claim 1, wherein the targeted website address is internal to the social network embodying the profile information.

3. The method of claim 1, further comprising applying a time of year filter when selecting the targeted website, such that the time of year filter automatically determines what information to show the user in the website based on an age and a marital status of the user captured through the profile information.

4. A method, comprising:
providing descriptive information of pre-seeded data having characteristics of people and communities in a geographic area;
generating a community network of user profiles based on the pre-seeded data, each user profile of the user profiles associated with a specific geographic location, at least some of the specific geographic locations associated with at least one of a business and a residence;
associating a first user with a first user profile of the user profiles having a specific geographic location associated with a first business;
claiming the first user profile of the user profiles;
selecting the first user profile by a second user profile based on a set of characteristics derived from the second user profile and the pre-seeded data; and
generating a three-dimensional map view embodied by the community network, at least a portion of the user profiles represented at locations in the three-dimensional map view corresponding with the specific geographic locations of the at least a portion of the user profiles, the first user profile, and information, based on at least a portion of the set of characteristics derived from the second user profile and the pre-seeded data.

5. The method of claim 4, wherein the claiming the first user profile of the user profiles includes verifying at least one of an email address, a business license, and a physical postal address.

6. The method of claim 4, wherein the first user profile displays at least one of:
advertisements based on the information, a link to a website associated with the first business, and the website associated with the first business.

7. The method of claim 6, wherein the website associated with the first business includes at least one of a web page and a link associated with the business.

8. The method of claim 7, further comprising generating an online transaction associated with the second user profile and the first business.

9. The method of claim 8, wherein the online transaction includes:
reserving at least one of a product and a service associated with the business;
ordering at least one of the product and the service associated with the business; and
generating an online payment transaction associated with the business.

10. The method of claim 6, wherein the generating an advertisement includes at least one of:
displaying an online advertisement;
generating a printed publication;
generating a printed publication from an online advertisement;
generating an advertisement based on a predetermined criterion associated with a second user profile of the user profiles; and
generating a display view of the first user profile of the user profiles and the advertisement, the display view associated with the second user profile of the user profiles.

11. The method of claim 4 in a form of a machine-readable medium embodying a set of instructions that, when executed by a machine, causes the machine to perform the method of claim 1.

12. A system, comprising:
a geographic community environment;
a community network module of the geographic community environment, the community network module to include user profiles, each user profile of the user profiles to include an associated specific geographic location, at least a portion of the specific geographic locations associated with at least one of a business and a residence;
a map module of the geographic community environment to include map data which serve as a basis to render a three-dimensional map view in the geo-spatial environment which identifies at least some physical structures having specific geographic locations;
a claim module of the geographic community environment to claim a first user profile of the user profiles having a specific geographic location associated with a business;
a display module of the geographic community environment to generate a display view of the three-dimensional map view embodied by the community network and a first user profile of the user profiles represented at a location in the three-dimensional map view associated with the specific geographic location of the first user profile of the user profiles; and
a transaction module of the geographic community environment to generate a promotion-related activity associated with the first user profile of the user profiles and the business.

13. The system of claim 12, further comprising a review control module of the geographic community environment to control the display of at least one review of reviews associated with the business.

14. The system of claim 13, further comprising a payment module of the geographic community environment to permit selective control over display of the at least one review of the reviews associated with the business upon a payment transaction.

15. The system of claim 12, further comprising a website matching module of the geographic community environment to incorporate a website associated with the business into the first user profile of the user profiles, wherein the website includes a display of at least one of a web page and a link associated with a business.

16. The system of claim 12, wherein the website matching module comprises at least one of:
a reservation transaction to generate a reservation associated with at least one of a product and a service associated with the business;
an order transaction to order at least one of the product and the service associated with the business; and
an online payment transaction associated with the business.

17. The system of claim 12, further comprising an advertisement module of the geographic community environment to generate an advertisement associated with the first user profile of the user profiles.

18. The system of claim 17, wherein the advertisement comprises at least one of:
an online advertisement display;
a printed publication; and
a printed publication generated from an online advertisement.

19. The system of claim 18, wherein the printed publication comprises a coupon, a flyer, and a post card.

20. The system of claim 19, wherein the advertisement module further comprises an advertisement, based on a predetermined criterion associated with a second user profile of the user profiles, displayed in conjunction with the first user profile of the user profiles.

21. The system of claim 20, further comprising a poll module of the geographic community environment to generate a poll associated with the business.

22. The system of claim 20, further comprising a sponsorship module of the geographic community environment to generate a list of groups seeking sponsorship and to display the first user profile of the user profiles in conjunction with a list of groups sponsored by the business.

23. The system of claim 12, further comprising a wiki module of the geographic community environment to generate in a display view, at least one of a wiki profile associated with a user profile of the user profiles and content associated with the wiki profile.

24. The system of claim 12, wherein the claim module further verifies a proof of business ownership.

25. The system of claim 24, wherein the proof of business ownership includes at least one of an email address, a business license, and a physical postal address verification.

26. A geographic community environment, comprising:
a first instruction set to enable a community network, to include a user database to include user profiles, the community network associated with map data, in which the community network is associated with specific geographic locations identifiable in the map data and at least a portion of the specific geographic locations are associated with at least one of a business and a residence;
a second instruction set integrated with the first instruction set to claim a user profile of the user profiles having a specific geographic location associated with a business; and
a third instruction set integrated with the first instruction set and the second instruction set to generate a promotion-related activity associated with the user profile of the user profiles and the business.

27. The geographic community environment of claim 26, further comprising:
a fourth instruction set integrated with the first instruction set, the second instruction set and the third instruction set to selectively display in conjunction with the user profile of the user profiles, at least one review of reviews associated with the business.
